(19) United States
(12) Patent Application Publication
(10) Pub. No.: US 2026/0254164 A1
(43) Pub. Date: Aug. 27, 2026

(54) Electrical Connector and Electrical Connector Assembly

(71) Applicant: Molex, LLC, Lisle, IL (US)

(72) Inventors: Yi-Tse Ho, New Taipei City (TW); Lupco Zabjanovski, Lisle, IL (US)

(21) Appl. No.: 19/468,553

(22) Filed: Feb. 3, 2026

(30) Foreign Application Priority Data
Feb. 7, 2025 (CN) 202510136902.6
May 8, 2025 (CN) 202510588175.7

(51) Int. Cl. H01R 13/631; H01R 12/71; H01R 27/02

(52) U.S. Cl. CPC H01R 13/631; H01R 12/716; H01R 27/02

(57) ABSTRACT

An electrical connector and an electrical connector assembly are provided. The electrical connector includes a housing and conductive terminals. The housing includes a base portion having terminal passageways which penetrate from a rear to front surfaces of the base portion. Terminals in the terminal passageways are exposed from the front surface of the base portion to form a contacting end portion, and a guiding portion which extends forwardly from the front surface to form a cooperating end portion. A distance between the cooperating end portion and the front surface is greater than a distance between the contacting end portion and the front surface. A side surface of the guiding portion has a placing groove which allows the corresponding conductive terminal to be inserted therein.

### TECHNICAL FIELD

The present disclosure relates to an electrical connector and an electrical connector assembly, and particularly relates to an electrical connector and an electrical connector assembly which are compact in structure.

### BACKGROUND

Electrical connectors can be adapted to various fields, the electrical connectors generally include a plug electrical connector and a receptacle electrical connector which are mated with each other to constitute an electrical connector assembly to realize transmission of current and signal. In order to facilitate mating between the plug electrical connector and the receptacle electrical connector, in general, two sides of a housing of the plug electrical connector in a transverse direction are provided with guiding posts respectively, and two sides of a housing of the receptacle electrical connector in a transverse direction are correspondingly provided with receiving grooves, that the guiding post and the receiving groove cooperate with each other facilitates guiding of the plug electrical connector and the receptacle electrical connector to be mated with each other.

However, since the provision of the guiding posts and the receiving grooves causes dimensions of the housings of the electrical connectors in the transverse direction to be increased, it is not beneficial to achieve the electrical connector which is compact in structure, in turn it is not beneficial to reduce the dimension of the electrical connector and reduce a space occupied by the electrical connector when the electrical connector is connected to, for example, a surface of a board.

### SUMMARY

In view of the above, an object of the present disclosure is to provide an electrical connector and an electrical connector assembly which are compact in structure, can effectively reduce a dimension of the electrical connector in a transverse direction, and at the same time still may satisfy the creepage distance requirement.

One aspect according to the present disclosure provides an electrical connector comprising a housing and conductive terminals, wherein the housing comprises: a base portion which is provided with a plurality of terminal passageways, the plurality of terminal passageways penetrate from a rear surface of the base portion to a front surface of the base portion, the conductive terminal is provided in the corresponding terminal passageway and is exposed from the front surface of the base portion to form a contacting end portion; and a guiding portion which extends forwardly from the front surface of the base portion to form a cooperating end portion, a distance between the cooperating end portion and the front surface of the base portion is greater than a distance between the contacting end portion of the conductive terminal and the front surface of the base portion, a side surface of the guiding portion is provided with a placing groove which allows the corresponding conductive terminal to be inserted therein, the placing groove is communicated with the corresponding terminal passageway so that a part of the corresponding conductive terminal is provided in the corresponding terminal passageway and a part of the corresponding conductive terminal is placed in the placing groove.

According to an embodiment, the guiding portion is provided at at least one side end portion of two side end portions of the base portion in a transverse direction, and the guiding portion is a partitioning plate which has a thickness.

According to an embodiment, the guiding portion is provided at at least one side end portion of two side end portions of the base portion in a transverse direction, and the guiding portion is two partitioning plates which are provided to be spaced apart from each other.

According to an embodiment, the two partitioning plates are filled therebetween with an insulator.

According to an embodiment, the cooperating end portion of the guiding portion is provided with a guiding oblique surface.

According to an embodiment, a top portion and/or a bottom portion of the guiding portion is provided with a recessed groove which extends along a front-rear direction.

According to an embodiment, when the top portion of the guiding portion is provided with the recessed groove which extends along the front-rear direction, the recessed groove extends rearwardly to a top portion of the base portion along the top portion of the guiding portion; when the bottom portion of the guiding portion is provided with the recessed groove which extends along the front-rear direction, the recessed groove extends rearwardly to a bottom portion of the base portion along the bottom portion of the guiding portion.

According to an embodiment, the guiding portion comprises a first guiding portion and a second guiding portion, the first guiding portion and the second guiding portion are respectively provided at two side end portions of the base portion in a transverse direction, and a width of the first guiding portion is greater than a width of the second guiding portion.

According to an embodiment, the base portion is further provided with a supporting arm, the supporting arm extends forwardly from the front surface of the base portion, and a distance that the supporting arm extends forwardly from the base portion is less than the distance between the cooperating end portion of the guiding portion and the front surface of the base portion; the conductive terminals comprises at least one ground terminal, the ground terminal is provided at either side of the supporting arm.

According to an embodiment, either side of the supporting arm is provided with an inserting groove, the ground terminal is partially provided in the corresponding terminal passageway and is partially inserted in the inserting groove.

According to an embodiment, the ground terminal is divided into a first ground terminal and a second ground terminal which are arranged to be spaced apart from each other.

According to an embodiment, the base portion is further provided with a second supporting arm, the second supporting arm is adjacent to one guiding portion and extends forwardly from the front surface of the base portion, and a distance that the second supporting arm extends forwardly from the base portion is less than the distance between the cooperating end portion of the guiding portion and the front surface of the base portion.

According to an embodiment, the conductive terminal comprises at least one power terminal, a side of the second supporting arm away from the adjacent guiding portion is provided with a second inserting groove, the corresponding power terminal is partially positioned in the corresponding terminal passageway and is partially inserted into the second inserting groove.

According to an embodiment, a side surface of the guiding portion adjacent to the second supporting arm away from the second supporting arm is provided with a placing groove, the corresponding power terminal is partially positioned in the corresponding terminal passageway and is partially positioned in the placing groove.

According to an embodiment, the conductive terminal comprises a lower-voltage side power terminal, the base portion is further provided with a third supporting arm, the third supporting arm is positioned at a position corresponding to the lower-voltage side power terminal and extends forwardly from the front surface of the base portion, and a distance that the third supporting arm extends forwardly from the base portion is less than the distance between the cooperating end portion of the guiding portion and the front surface of the base portion.

According to an embodiment, the conductive terminal further comprises a ground terminal, a left side and a right side of the third supporting arm each are provided with a third inserting groove, the lower-voltage side power terminal is partially inserted into the corresponding terminal passageway and is partially inserted into the third inserting groove at one side of the third supporting arm, the ground terminal is partially inserted into the corresponding terminal passageway and is partially inserted into the third inserting groove at the other side of the third supporting arm.

According to an embodiment, the base portion is further provided with a compartment, the compartment extends forwardly from the front surface of the base portion, and a distance that the compartment extends forwardly from the base portion is less than the distance between the cooperating end portion of the guiding portion and the front surface of the base portion; the conductive terminals comprises a signal terminal group constituted by a plurality of signal terminals which are arranged, the signal terminal group is provided in the compartment.

According to an embodiment, the conductive terminals further comprises power terminals, the power terminals comprise a lower-voltage side power terminal which is positioned at one side of the signal terminal group and high-voltage side power terminals which are positioned at the other side of the signal terminal group.

According to an embodiment, the electrical connector is further provided with at least one detecting terminal.

According to an embodiment, the detecting terminal is also provided in the compartment, and is positioned alongside the plurality of signal terminals, and the detecting terminal and the plurality of signal terminals are provided therebetween with a partitioning wall.

According to an embodiment, the detecting terminals also are provided therebetween with a partitioning wall.

According to an embodiment, the detecting terminal and the power terminal which has the same electric potential as the detecting terminal are connected as integral by insert molding.

Another aspect according to the present disclosure further provides an electrical connector assembly, comprising: the electrical connector as described above; and a counterpart electrical connector which is mated with the electrical connector, the counterpart electrical connector comprises a counterpart housing and counterpart conductive terminals, the counterpart housing is provided with counterpart terminal passageways, the counterpart conductive terminals are provided in the respective counterpart terminal passageways and correspond to and are mated with the respective conductive terminals of the electrical connector to realize electrical connection, wherein the counterpart housing comprises: a guiding portion receiving portion which is communicated with the corresponding counterpart terminal passageway and is used to receive the guiding portion of the electrical connector; and conductive terminal receiving portions which are communicated with the respective counterpart terminal passageways and are used to receive the respective conductive terminals of the electrical connector; wherein the guiding portion receiving portion and the conductive terminal receiving portions are provided on a mating surface of the counterpart housing, and extend from the mating surface toward an interior of the counterpart housing.

According to an embodiment, the counterpart housing of the counterpart electrical connector further comprises: a supporting arm receiving portion which is used to receive the supporting arm of the electrical connector, the supporting arm receiving portion is provided on the mating surface of the counterpart housing of the counterpart electrical connector and extends from the mating surface toward the interior of the housing; and a signal terminal group cooperating portion which is used to cooperate with the signal terminal group of the electrical connector to realize mating, and when the electrical connector and the counterpart electrical connector are mated with each other, the signal terminal group cooperating portion is received in the compartment of the electrical connector.

According to an embodiment, the counterpart housing of the counterpart electrical connector further comprises: a detecting terminal cooperating portion which is used to cooperate with the detecting terminal of the electrical connector to realize mating, and when the electrical connector and the counterpart electrical connector are mated with each other, the detecting terminal cooperating portion is received in the compartment of the electrical connector.

According to an embodiment, the guiding portion extends forwardly from the front surface of the base portion to form the cooperating end portion, or the guiding portion extends forwardly from the rear surface of the base portion to be beyond the front surface to form the cooperating end portion.

According to an embodiment, one end of the base portion in a transverse direction is provided with a compartment which is used to receive a signal terminal group, a top portion of the compartment is provided with a guiding post; the other end of the base portion in the transverse direction is provided with the guiding portion.

According to an embodiment, the guiding post is in form of semi-cylinder or cylinder, and a front end of the guiding post is formed as a semi-cone or a cone, the semi-cone or the cone of the front end of the guiding post extends forwardly along the top portion of the compartment to be beyond a front surface of the compartment.

According to an embodiment, soldering legs of the high-voltage side power terminals are arranged to be staggered with each other so that an imaginary line connected between the soldering legs of the adjacent high-voltage side power terminals is an oblique line.

According to an embodiment, a bottom surface of the base portion is formed thereon with a plurality of protruding portions and a plurality of recessed portions which are spaced apart from each other, the plurality of recessed portions are lower than the bottom surface, the plurality of protruding portions are flush with the bottom surface or are higher than the bottom surface.

According to an embodiment, the guiding portion receiving portion is formed at one end of the counterpart housing; the other end of the counterpart housing is formed with a signal terminal group cooperating portion which cooperates with the signal terminal group of the electrical connector, a guiding post receiving portion is provided above the signal terminal group cooperating portion to receive the guiding post of the electrical connector.

According to an embodiment, the guiding post receiving portion is formed with a groove which is opened toward the signal terminal group cooperating portion, when the counterpart electrical connector and the electrical connector are mated with each other, the guiding post extends into the groove.

The present disclosure further provides an electrical connector comprising a housing and conductive terminals, wherein, one part of the conductive terminals of the electrical connector is electrically connected to a printed circuit board, the other part of the conductive terminals of the electrical connector is electrically connected to a busbar.

According to an embodiment, that the other part of the conductive terminals of the electrical connector is electrically connected to the busbar comprises: the other part of the conductive terminals of the electrical connector is electrically connected to a flexible busbar, the flexible busbar is electrically connected to a rigid busbar.

The electrical connector according to the present disclosure is provided with the guiding portion in a transverse direction of the housing, two sides of the guiding portion each are provided with the power terminal, so that a guiding post which is provided on a housing in the prior art may be omitted, a dimension of the electrical connector in the transverse direction is effectively reduced, the creepage distance requirement still may be satisfied at the same time.

### BRIEF DESCRIPTION OF THE DRAWINGS

The drawings is included herein to provide a further understanding of the present disclosure and is incorporated into the specification to constitute a part of the specification. The drawings illustrates embodiments of the present disclosure, the drawings and the following description together are used to describe the concept of the present disclosure, in the drawings:

FIG. 1 is a structure schematic view of one embodiment of an electrical connector according to the present disclosure with conductive terminals not assembled into a housing;

FIG. 2 is another structure schematic view of the one embodiment of the electrical connector according to the present disclosure with the conductive terminals assembled into the housing;

FIG. 3 is a structure schematic view of another embodiment of the electrical connector according to the present disclosure with conductive terminals not assembled into a housing;

FIG. 4 is a structure schematic view of the another embodiment of the electrical connector according to the present disclosure from another angle with the conductive terminal not assembled into the housing;

FIG. 5 is a structure schematic view of the another embodiment of the electrical connector according to the present disclosure with the conductive terminal assembled into the housing;

FIG. 6 is a schematic view illustrating a power terminal and a detecting terminal according to the another embodiment;

FIG. 7 is a structure schematic view illustrating an electrical connector according to a further embodiment;

FIG. 8 is a structure schematic view illustrating an electrical connector according to further another embodiment;

FIGS. 9 and 10 are structure schematic views illustrating an electrical connector according to still another embodiment;

FIGS. 11 and 12 are structure schematic view illustrating an electrical connector according to yet another embodiment;

FIG. 13 is a schematic view illustrating an electrical connector assembly according to the present disclosure with the electrical connector and a counterpart electrical connector not mated with each other;

FIG. 14 is a schematic view illustrating the electrical connector assembly according to the present disclosure with the electrical connector and a counterpart electrical connector mated with each other;

FIG. 15 is a structure schematic view of one embodiment of the counterpart electrical connector according to the present disclosure;

FIG. 16 is a structure schematic view of another embodiment of the counterpart electrical connector according to the present disclosure;

FIG. 17 is a schematic view illustrating a varied embodiment of the electrical connector in plug-type according to the present disclosure;

FIG. 18 is a schematic view illustrating the varied embodiment of the electrical connector in plug-type according to the present disclosure from another angle;

FIG. 19 is a schematic view illustrating an arrangement structure of soldering legs of high-voltage side power terminals;

FIGS. 20A and 20B are schematic views illustrating another arrangement structures of the soldering legs of the high-voltage side power terminals;

FIG. 21 is a schematic view illustrating a bottom structure of an electrical connector in plug-type according to the present disclosure;

FIG. 22 is a schematic view illustrating a varied embodiment of a counterpart electrical connector in receptacle-type according to the present disclosure;

FIG. 23 is schematic view illustrating a bottom structure of the counterpart electrical connector in receptacle-type according to the present disclosure; and

FIG. 24 is a schematic view illustrating bottom surfaces of the electrical connector and the counterpart electrical connector according to the present disclosure after mated with each other.

Reference numerals are presented as follows.

1 electrical connector assembly

10 electrical connector

11 first printed circuit board

11a first gap

100 housing

110 base portion

112 terminal passageway

112a first part

112b second part

112c third part

114 bottom surface

115 front surface

116 rear surface

117 supporting arm

1171 inserting groove

118 compartment

1181 partitioning wall

1182 partitioning groove

119 second supporting arm

1191 second inserting groove

113 third supporting arm

1131 third inserting groove

120 guiding portion

120a first guiding portion

120b second guiding portion

123 recessed groove

121 cooperating end portion

121a guiding oblique surface

124 placing groove

130 guiding post

140 protruding portion

150 recessed portion

200 conductive terminal

201 contacting end portion

210 power terminal

210a high-voltage side power terminal

212 soldering leg

210b lower-voltage side power terminal

210c ground terminal

210c1 first ground terminal

210c2 second ground terminal

220 signal terminal group

230 detecting terminal

30 counterpart connector

31 second printed circuit board

31a second gap

32 flexible busbar

33 rigid busbar

34 bushing

35 partitioning protrude block

36 partitioning wall

300 counterpart housing

320 mating surface

330 guiding portion receiving portion

340 conductive terminal receiving portion

350 supporting arm receiving portion

360 signal terminal group cooperating portion

370 detecting terminal cooperating portion

380 guiding post receiving portion

382 groove

390 bottom surface

392 protruding portion

400 counterpart conductive terminal

410 counterpart power terminal

410a high-voltage side counterpart power terminal

410b lower-voltage side counterpart power terminal

410c counterpart ground terminal

420 counterpart signal terminal group

430 counterpart detecting terminal

### DETAILED DESCRIPTION

Hereinafter, exemplary embodiments will be described in detail with reference to the drawings. Although the present disclosure is susceptible to various modifications and alternative forms, its specific embodiments are illustrated by way of example in the drawings. However, the present disclosure should not be construed as limited to the embodiments set forth herein, but rather as covering all modified, equivalent, and alternative solutions fallen within the spirit and scope of the embodiments.

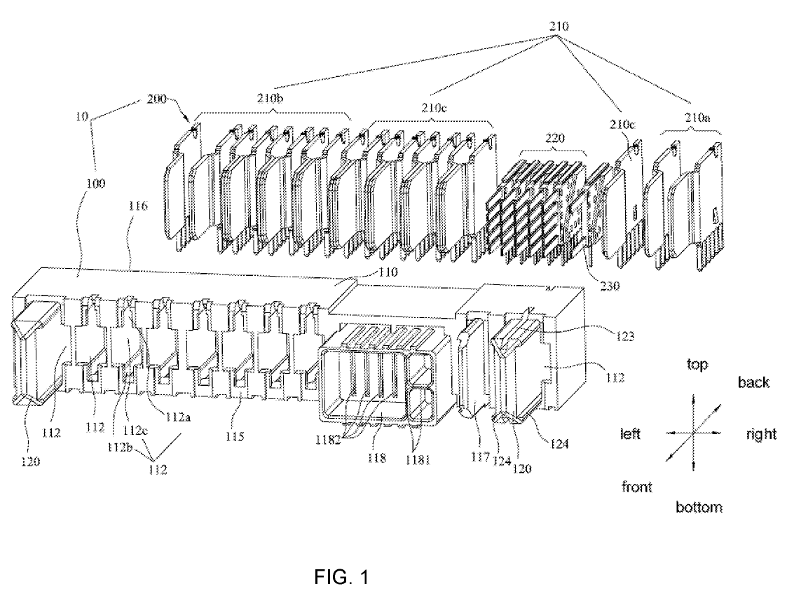

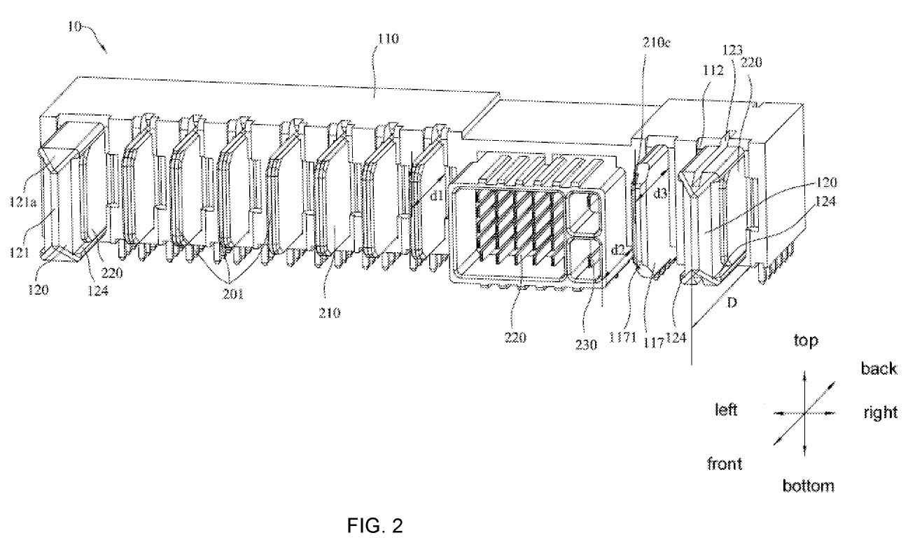

Hereinafter an electrical connector 10 according to the present disclosure will be described with reference to FIGS. 1 and 2, FIGS. 1 and 2 illustrate schematic structures of an electrical connector 10 in plug-type, the electrical connector 10 mainly includes a housing 100 and a group of conductive terminals 200, according to an embodiment, the group of conductive terminals 200 may include a power terminal 210, a signal terminal group 220 and a detecting terminal 230, the signal terminal group 220 is generally arranged as an array. Certainly, the detecting terminal 230 also may be omitted according to practical application requirement on the electrical connector 10. Similarly, according to practical application requirement on the connector, the power terminal 210 may include a high-voltage side power terminal 210a and a lower-voltage side power terminal 210b, may further include ground terminals 210c. In the ground terminals 210c, the ground terminal 210c which is used to cooperate with the high-voltage side power terminal 210a may be referred to as a ground terminal at the high-voltage side; the ground terminal 210c which is used to cooperate with the lower-voltage side power terminal 210b may be referred to as a ground terminal at the lower-voltage side.

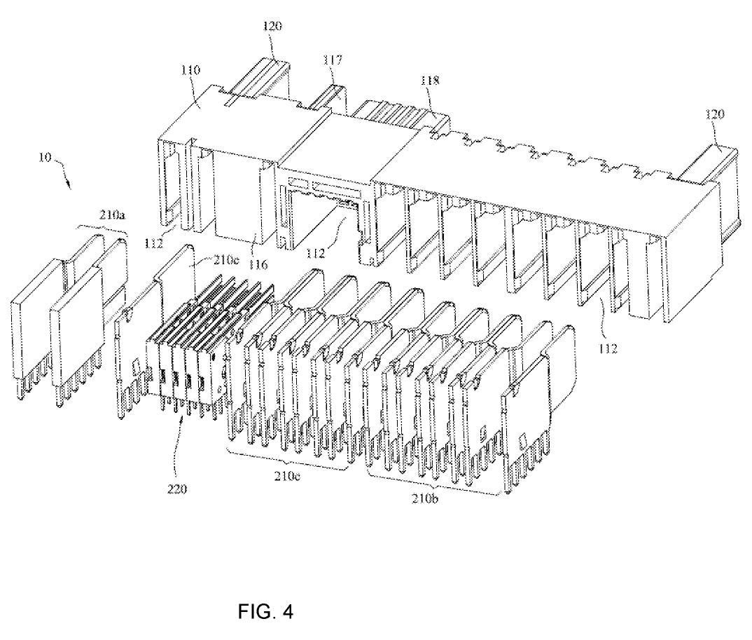

According to the embodiment as shown in FIGS. 1 and 2, the housing 100 is generally formed by an insulative material and includes a base portion 110 and a guiding portion 120, certainly, the housing 100 also may be formed by other suitable material, for example, may be formed by molding a plastic part and a metal part together. The base portion 110 is provided with a plurality of terminal passageways 112 (for sake of brevity, only a part of the plurality of terminal passageways 112 is shown in the figures), the plurality of terminal passageways 112 penetrates from a rear surface 116 of the base portion 110 to a front surface 115 of the base portion 110. In conjunction with reference to FIG. 4, the terminal passageway 112 is formed as an inverted U-shape, which makes a bottom thereof opened, at the rear surface 116, and the terminal passageways 112 are formed in form of rabbet, including a first part 112a which is positioned at an upper portion of the terminal passageway 112, a second part 112b which is positioned at a lower portion of the terminal passageway 112, and a third part 112c which is positioned between the first part 112a and the second part 112b, at the front surface 115, as shown in FIG. 1, a width of the first part 112a and a width of the second part 112b are relatively small, and a width of the third part 112c is relatively large, which may facilitate passing through and inserting of the conductive terminal 200 on one hand and may further position and support the conductive terminal 200 on the other hand. Certainly, an inner side wall of the terminal passageway 112 also may be provided thereon with a shoulder or protrusion to assist in positioning and supporting of the conductive terminal 200. As shown in FIG. 2, each conductive terminal 200 is inserted into the corresponding terminal passageway 112 from the rear surface 116 of the base portion 110, and a contacting end portion 201 of each conductive terminal 200 passes through terminal passageway 112 and extends out of the front surface 115 of the base portion 110.

Moreover, the base portion 110 may be further provided with a compartment 118, as shown in FIGS. 1 and 2, the compartment 118 extends forwardly from the front surface 115 of the base portion 110, and is communicated with the corresponding terminal passageway 112 (as shown in FIG. 4). The signal terminal group 220 which is constituted by multiple signal terminal arrays is provided in the compartment 118. As shown in FIG. 1, the compartment 118 also may be communicated with the corresponding terminal passageway 112 via multiple partitioning grooves 1182, as such, the signal terminals of each column may be inserted into the corresponding terminal passageway 112 from the rear surface 116 of the base portion 110 and then passes through the respective partitioning groove 1182 to be received in the compartment 118. For example, the partitioning groove 1182 may be an elongated groove which extends from up to down, and may allow a whole column of signal terminals to pass therethrough. As shown in FIG. 1, the lower-voltage side power terminal 210b is provided adjacent to a left side of the signal terminal group 220, the high-voltage side power terminal 210a is provided adjacent to a right side of the signal terminal group 220, but the present disclosure is not limited thereto.

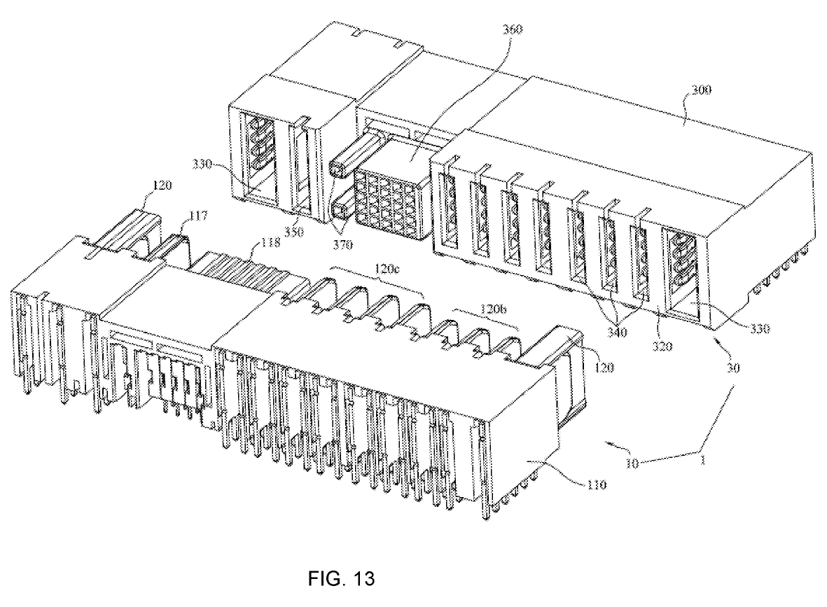

Moreover, as shown FIGS. 1 and 2, the electrical connector 10 according to the present disclosure is further provided with the guiding portion 120.Two side end portions of the base portion 110 along a transverse direction (a left-right direction in FIG. 1) of the base portion 110 each may be provided with the guiding portion 120, also only one of the two side end portions may be provided with the guiding portion 120, for example, only a left side end portion or a right side end portion may be provided with the guiding portion 120. In other embodiments, the guiding portion 120 also may be provided in the middle of the base portion 110 or at a position offsetting from the middle of the base portion 110 toward one of the two side end portions of the base portion 110 along the transverse direction of the base portion 110. The guiding portion 120 extends forwardly from the front surface 115 of the base portion 110 along a front-rear direction of FIG. 1 to form a cooperating end portion 121 (as shown in FIG. 2), a distance D between the cooperating end portion 121 and the front surface 115 of the base portion 110 is greater than a distance d1 between the contacting end portion 201 of each conductive terminal 200 and the front surface 115, also is greater than a distance d2 that the compartment 118 extends forwardly from the front surface 115 along the front-rear direction of FIG. 1. That is to say, a distance that the guiding portion 120 extends out from the front surface 115 of the base portion 110 is maximum, as such, when the electrical connector 10 and the counterpart electrical connector 30 (as shown in FIGS. 12 and 13) are mated with each other, the guiding portion 120 may function as guiding. In order to better realize guiding function, the cooperating end portion 121 of the guiding portion 120 is further provided with a guiding oblique surface 121a. As shown in FIGS. 1 and 2, an upper end portion and a lower end portion of the cooperating end portion 121 each may be provided with the guiding oblique surface 121a, but the present disclosure is not limited thereto. For example, a left side and a right side of the cooperating end portion 121 each may be provided with the guiding oblique surface 121a.

A side surface of the guiding portion 120 is further provided with a placing groove 124 which allows the conductive terminal 200 to be inserted therein, FIGS. 1 and 2 illustrate that two side surfaces of the guiding portion 120 each are provided with the placing groove 124, certainly, it also may be that only one side surface of the guiding portion 120 is provided with the placing groove 124 according to practical requirement. The placing groove 124 is communicated with the corresponding terminal passageway 112, as such, after the conductive terminal 200 is inserted into the terminal passageway 112, a part of the conductive terminal 200 is provided in the terminal passageway 112, a part of the conductive terminal 200 is placed in the placing groove 124, as shown in FIG. 2.

The guiding portion 120 may be a partitioning plate having a certain thickness, or may be two partitioning plates which are provided to be spaced apart from each other, and an insulator is filled between the two partitioning plates, but the present disclosure is not limited thereto, as long as the conductive terminal 200 positioned on the side surface of the guiding portion 120 and the adjacent conductive terminal 200 therebetween can satisfy creepage distance. According to the present disclosure, the guiding portion 120 may provide guiding function when the electrical connector 10 and the counterpart electrical connector 30 are mated with each other. At the same time because one side surface or two side surfaces of the guiding portion 120 each are provided with the placing groove 124, the conductive terminal 200 may be inserted into the placing groove 124. Therefore, while guiding function is realized, the provision of the guiding portion 120 does not increase an overall transverse width of the electrical connector 10, and by setting a thickness of the guiding portion 120, the conductive terminals 200 respectively at two sides of the guiding portion 120 can satisfy the creepage distance requirement.

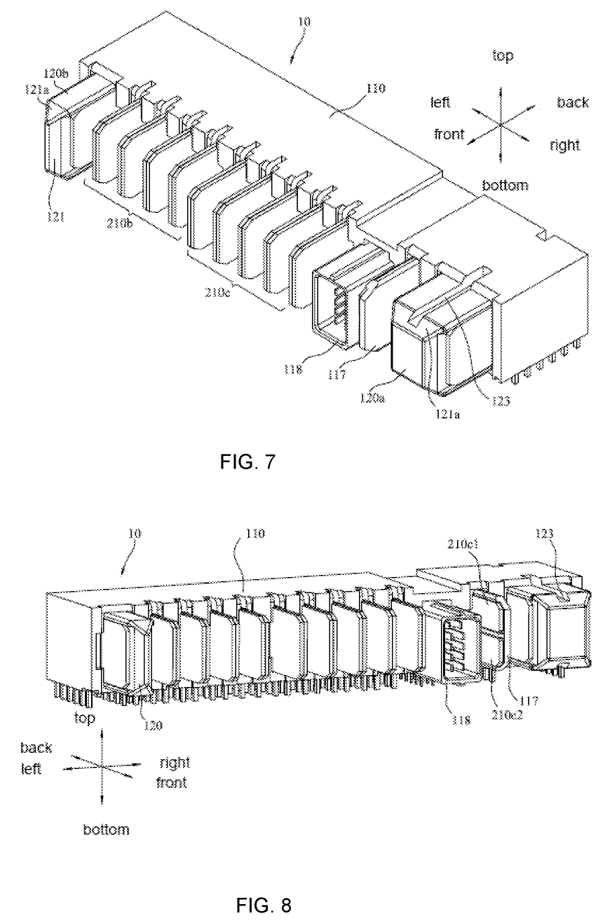

As shown in FIGS. 1 and 2, a top portion of the guiding portion 120 is further provided with a recessed groove 123 which extends along the front-rear direction (FIGS. 7, 8, 11 and 12 similarly illustrate the recessed groove 123, which will be not repeatedly described later), the recessed groove 123 may extend rearwardly along the top portion of the guiding portion 120 to a top portion of the base portion 110, but the present disclosure is not limited thereto. Similarly, a bottom portion of the guiding portion 120 may be provided with a recessed groove 123 which extends along the front-rear direction, the recessed groove 123 may extend rearwardly along the bottom portion of the guiding portion 120 to a bottom portion of the base portion 110, but the present disclosure is not limited thereto. The recessed groove 123 may further increase creepage distance between the conductive terminals 200.

Moreover, referring to FIG. 7, FIG. 7 illustrates a structure schematic view of an electrical connector 10 according to a further embodiment. In FIG. 7, the guiding portion 120 includes a first guiding portion 120a which is provided at a right end of the base portion 110 and a second guiding portion 120b which is provided at a left end of the base portion 110, according to the further embodiment, in FIG. 7, a left side part of the base portion 110 is provided with the lower-voltage side power terminal 210b, and a right side part of the base portion 110 is provided with the high-voltage side power terminal 210a. In accordance with safety specification requirement, higher voltage levels are associated with greater creepage distance, so a width of the first guiding portion 120a is greater than a width of the second guiding portion 120b, such that the creepage distance requirements of the high-voltage side power terminal 210a and the lower-voltage side power terminal 210b may be respectively satisfied.

Returning to FIGS. 1 and 2 again, the base portion 110 is further provided with a supporting arm 117, the supporting arm 117 also extends forwardly from the front surface 115 of the base portion 110, and the distance D between the cooperating end portion 121 of the guiding portion 120 and the front surface 115 of the base portion 110 is also greater than a distance d3 (as shown in FIG. 2) that the supporting arm 117 extends forwardly from the front surface 115 along the front-rear direction of FIG. 1, to ensure that guiding function of the guiding portion 120 is not interfered. Considering that a dimension of the ground terminal 210c at the high-voltage side is generally larger, the supporting arm 117 may be used to support the ground terminal 210c at the high-voltage side, but the present disclosure is not limited thereto. Specifically, as shown in FIGS. 1 and 2, either side of the supporting arm 117 may be provided with an inserting groove 1171, in conjunction with referring to FIG. 4, after the ground terminal 210c at the high-voltage side is inserted into the terminal passageway 112 from the rear surface 116 of the base portion 110, the ground terminal 210c at the high-voltage side is partially positioned in the terminal passageway 112, and is partially inserted into the inserting groove 1171, so that the ground terminal 210c at the high-voltage side can be better positioned and supported by the supporting arm 117.

Moreover, as shown in FIG. 8 which illustrates a structure schematic view of an electrical connector 10 according to further another embodiment, in the embodiment as shown in FIG. 8, the ground terminal 210c may be divided into a first ground terminal 210c1 and a second ground terminal 210c2 according to practical requirement, the first ground terminal 210c1 and the second ground terminal 210c2 may be provided to be spaced apart from each other along an up-down direction, as shown in FIG. 8, but the present disclosure is not limited thereto, the first ground terminal 210c1 and the second ground terminal 210c2 also may be provided to be spaced apart from each other along the left-right direction, so that different grounding requirements are satisfied.

Returning to FIGS. 1 and 2 again, the electrical connector 10 may be further provided with detecting terminals 230 according to requirement, certainly, the detecting terminals 230 may be omitted according to practical requirement. In the embodiment as shown in FIGS. 1 and 2, the detecting terminals 230 are also provided in the compartment 118 and are positioned alongside the signal terminal group 220, the detecting terminals 230 and the signal terminal group 220 are provided therebetween with a partitioning wall 1181 (for example, the partitioning wall 1181 which extends along the up-down direction in FIG. 1), the detecting terminals 230 also are provided therebetween with a partitioning wall 1181 (for example, the partitioning wall 1181 which extends along the left-right direction in FIG. 1), the partitioning wall 1181 may protect the signal terminal and the detecting terminal 230 on one hand, and may further increase creepage distance on the other hand.

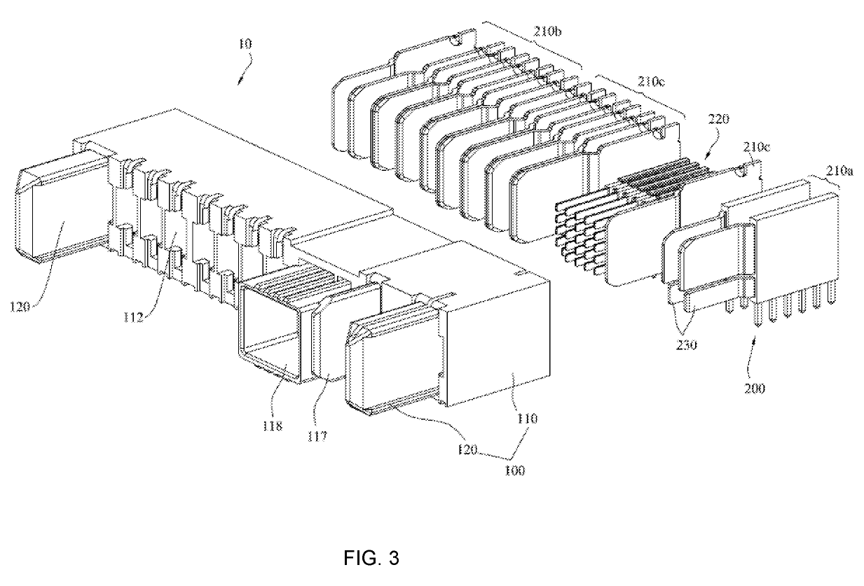

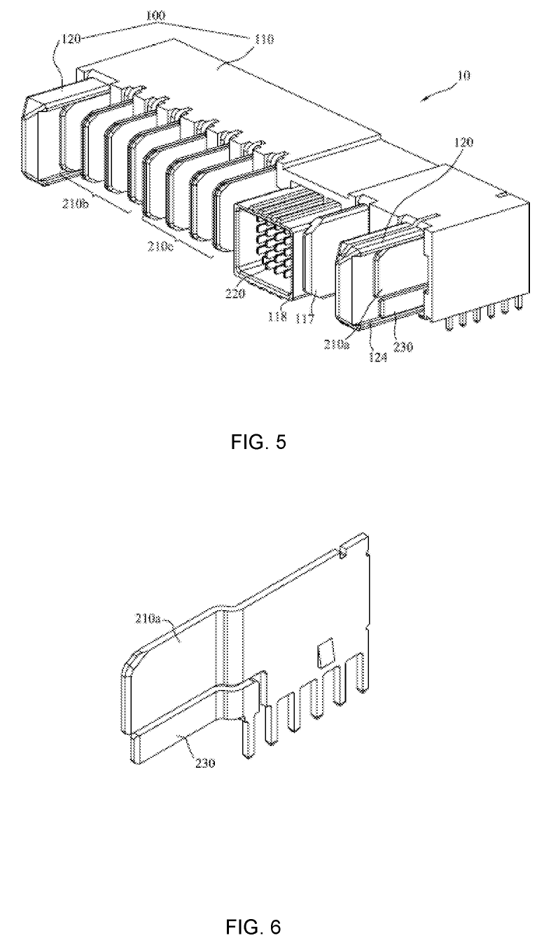

Next, referring to FIG. 3, FIG. 4, FIG. 5, FIG. 6, an electrical connector 10 according to another embodiment is described, where, FIGS. 3 and 4 illustrate a state that the conductive terminals 200 are not assembled into the housing 100, FIG. 3 is a view from a front side of the electrical connector 10, and FIG. 4 is a view from a rear side of the electrical connector 10; FIG. 5 illustrates a state that the conductive terminals 200 are assembled into the housing 100, and FIG. 6 illustrates a structure of the power terminal 210 and the detecting terminal 230 according to the embodiment. The detecting terminal 230 of the embodiment is no longer provided in the compartment 118, but is integrated with the power terminal 210, which has the same electric potential as the detecting terminal 230, as integral, for example, the detecting terminal 230 and the power terminal 210 may be connected as integral by insert molding. The power terminal 210 and the detecting terminal 230 which have the same electric potential do not need to consider creepage distance, so the power terminal 210 and the detecting terminal 230 may be directly integrated as integral. Preferably, when a current carried by the high-voltage side power terminal 210a is less than a current carried by the lower-voltage side power terminal 210b, the detecting terminal 230 and the high-voltage side power terminal 210a which has the same electric potential as the detecting terminal 230 may be integrated as integral. This is because a cross-sectional area of the power terminal 210 carrying small current is smaller, such that the sufficient space may be available to accommodate the detecting terminal 230, so that limited space may be further reasonably utilized. Moreover, according to the embodiment, because the detecting terminal 230 and the power terminal 210 which has the same electric potential as the detecting terminal 230 are connected as integral by insert molding, a width of the electrical connector 10 along the left-right direction may be further decreased.

As shown in FIG. 6, the detecting terminal 230 may be positioned in front of and below the high-voltage side power terminal 210a, but the present disclosure is not limited thereto. A distance between a contacting end portion of the detecting terminal 230 and the front surface 115 of the base portion 110 is less than a distance between a contacting end portion of the high-voltage side power terminal 210a and the front surface 115 of the base portion 110.

Other structures of the electrical connector 10 of the embodiment are the same as those structures of the electrical connector as shown in FIGS. 1 and 2, and are no longer described repeatedly.

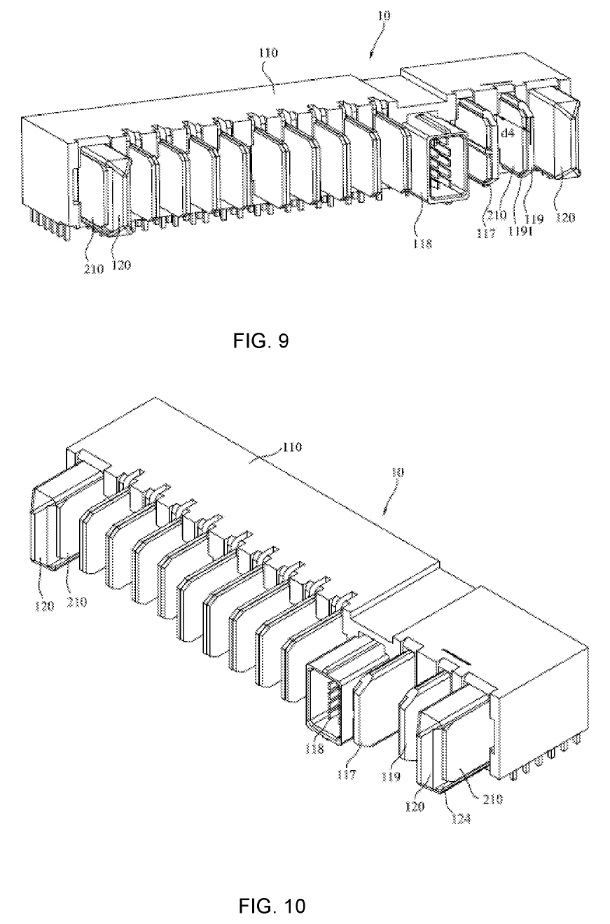

Next referring to FIGS. 9 and 10, a structure of an electrical connector 10 according to still another embodiment is described. In the embodiment, the base portion 110 is further provided with a second supporting arm 119, the second supporting arm 119 is positioned between the supporting arm 117 and the guiding portion 120 which is positioned at a right side of the base portion 110. Similarly, the distance D (as shown in FIG. 2) between the cooperating end portion 121 of the guiding portion 120 and the front surface 115 of the base portion 110 also is greater than a distance d4 that the second supporting arm 119 extends from the front surface 115 along the front-rear direction (as shown in FIG. 9), to ensure that guiding function of the guiding portion 120 is not interfered. Moreover, in the embodiment, a right side surface of the guiding portion 120 at the right side away from the second supporting arm 119 is provided with a placing groove 124, a part of the power terminal 210 which extends out of the front surface 115 of the base portion 110 is placed in the placing groove 124, a left side surface of the guiding portion 120 at the right side is not provided with any placing groove and any power terminal; a left side surface of the second supporting arm 119 away from the guiding portion 120 at the right side is provided with a second inserting groove 1191, a part of the power terminal 210 which extends out of the front surface 115 of the base portion 110 is inserted into the second inserting groove 1191, that is, the power terminal 210 is partially positioned in the terminal passageway 112, and is partially inserted into the second inserting groove 1191. In the embodiment, by that the second supporting arm 119 is provided, and by that a left side of the second supporting arm 119 and a right side of the guiding portion 120 are respectively provided with the power terminals 210, more sufficient creepage distance can be provided, a high creepage distance requirement is satisfied.

Other structures of the electrical connector 10 of the embodiment are the same as those structures of the electrical connector as shown in FIGS. 1 and 2 or those structures of the electrical connector as shown in FIG. 3, and are no longer described repeatedly.

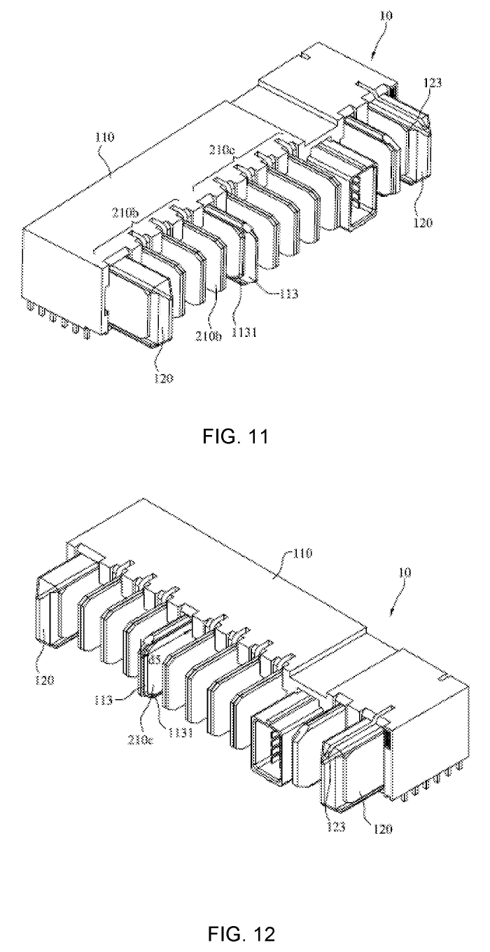

Next referring to FIGS. 11 and 12, a structure of an electrical connector 10 according to yet another embodiment is described, in the embodiment, the base portion 110 is further provided with a third supporting arm 113, the third supporting arm 113 is positioned at a position corresponding to the lower-voltage side power terminal 210b, and similarly, the distance D (as shown in FIG. 2) between the cooperating end portion 121 of the guiding portion 120 and the front surface 115 of the base portion 110 also is greater than a distance d5 (as shown in FIG. 12) that the third supporting arm 113 extends forwardly from the front surface 115 along the front-rear direction, to ensure that guiding function of the guiding portion 120 is not interfered. Moreover, in the embodiment, a left side surface and a right side surface of the third supporting arm 113 each are provided with a third inserting groove 1131, the lower-voltage side power terminal 210b is partially inserted into the terminal passageway 112 and is partially inserted into the third inserting groove 1131 at the left side surface of the third supporting arm 113, and the ground terminal 210c at the lower-voltage side is partially inserted into the terminal passageway 112 and is partially inserted into the third inserting groove 1131 at the right side surface of the third supporting arm 113. According to the embodiment, the lower-voltage side power terminal 210b in form of single sheet and the ground terminal 210c at the lower-voltage side in form of single sheet are respectively mounted on the two side surfaces of the third supporting arm 113, a length of the electrical connector 10 along the left-right direction may be effectively reduced. For example, in large current application at the lower-voltage side, if the lower-voltage side power terminal 210b as standard is constituted by two terminals which each are in form of sheet, it is assumed that a rated current that the lower-voltage side power terminal 210b as standard may carry is M ampere, if a rated current of large current at the lower-voltage side of the electrical connector is 4.5*M ampere, it may employ four lower-voltage side power terminals 210b as standard and one lower-voltage side power terminal 210b which is constituted by one terminal in form of sheet. Similarly, so the ground terminal 210c at the lower-voltage side does. With the above structure, the lower-voltage side power terminal 210b in form of single sheet and the ground terminal 210 at the lower-voltage side in form of single sheet are respectively mounted on the two side surfaces of the third supporting arm 113, not only practical application requirement on large current can be satisfied, but also the length of the electrical connector 10 along the left-right direction may further be effectively decreased in comparison with a case that practical application requirement on large current is attained by providing five lower-voltage side power terminals as standard and five ground terminals at the lower-voltage side as standard.

Other structures of the electrical connector 10 of the embodiment are the same as those structure of the electrical connector as shown in FIGS. 1 and 2 or those structure of the electrical connector as shown in FIG. 3, and are no longer described repeatedly.

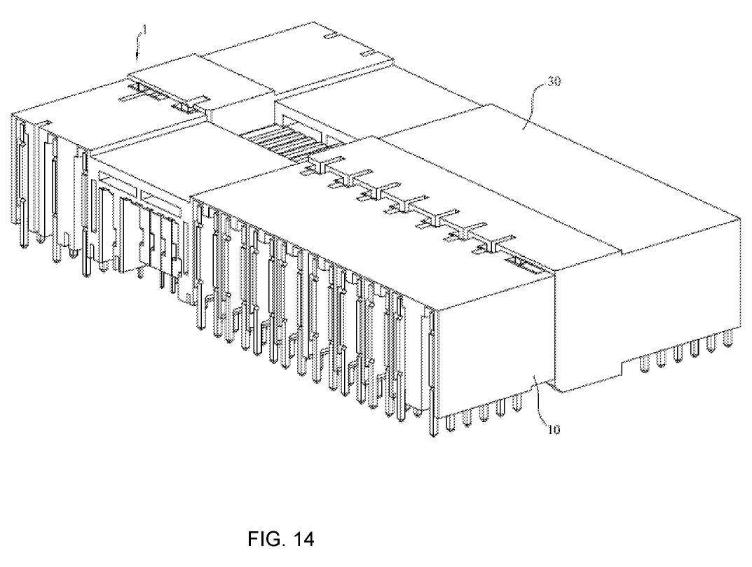

Hereinafter, referring to FIGS. 13 and 14, an electrical connector assembly 1 according to the present disclosure is described. The electrical connector assembly 1 includes the electrical connector 10 in plug-type, the electrical connector 10 may be the electrical connector 10 of the embodiments as correspondingly shown in in FIG. 1-FIG. 12. Moreover, the electrical connector assembly 1 further includes a counterpart electrical connector 30, mating between the electrical connector 10 and the counterpart electrical connector 30 may complete transmission of power and signal. FIG. 13 illustrates the electrical connector 10 and the counterpart electrical connector 30 which are not mated with each other, and FIG. 14 illustrates the electrical connector 10 and the counterpart electrical connector 30 which are mated with each other.

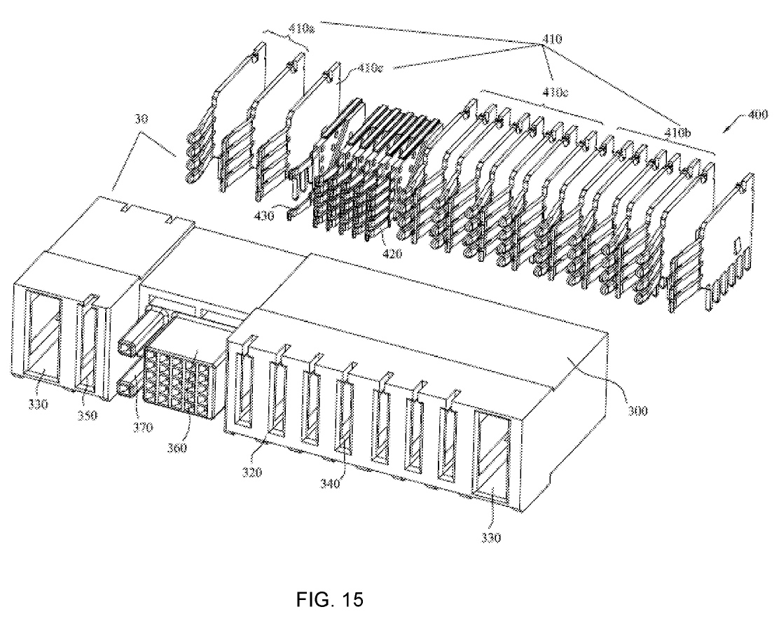

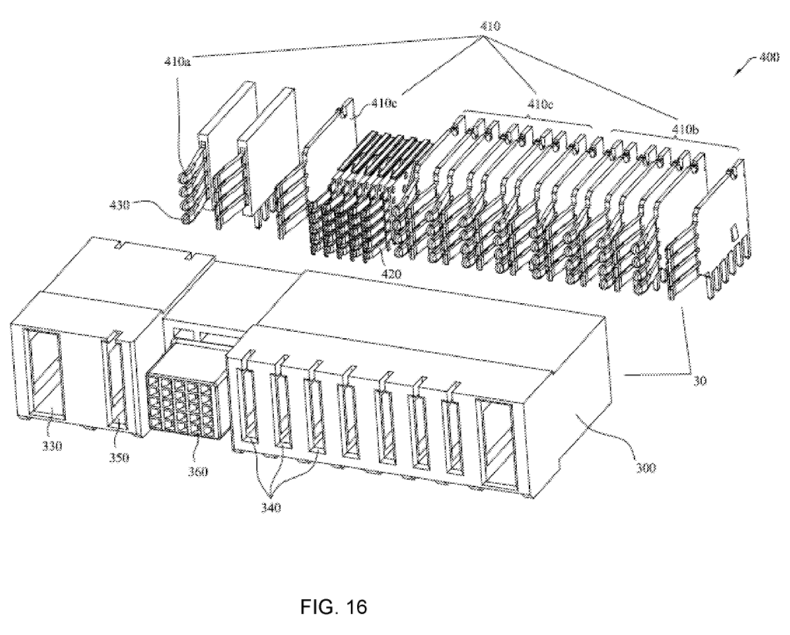

In conjunction with referring to FIGS. 15 and 16, a schematic structure of the counterpart electrical connector 30 is illustrated. Similarly, the counterpart electrical connector 30 also includes a counterpart housing 300 and counterpart conductive terminals 400. After the counterpart electrical connector 30 and the electrical connector 10 are mated with each other, the counterpart conductive terminals 400 and the conductive terminals 200 form electrical contact to realize transmission of power and signal. Similarly, the counterpart housing 300 is provided with counterpart terminal passageways, the counterpart conductive terminals 400 are correspondingly provided in the respective counterpart terminal passageways. Corresponding to the conductive terminals 200 of the electrical connector 10, the counterpart conductive terminals 400 also may include a counterpart power terminal 410, a counterpart signal terminal group 420 and a counterpart detecting terminal 430, the counterpart signal terminal group 420 is generally arranged as an array. Certainly, the counterpart detecting terminal 430 also may be omitted according to different embodiments of the electrical connector 10. Similarly, corresponding to the electrical connector 10, the counterpart power terminal 410 may include a high-voltage side counterpart power terminal 410a and a lower-voltage side counterpart power terminal 410b, may further include counterpart ground terminals 410c. The counterpart ground terminals 410c include a counterpart ground terminal at the lower-voltage side which corresponds to the ground terminal at the lower-voltage side and a counterpart ground terminal at the high-voltage side which corresponds to the ground terminal at the high-voltage side.

Moreover, corresponding to the structure of the electrical connector 10, the counterpart electrical connector 30 may further include a guiding portion receiving portion 330 which is communicated with the corresponding counterpart terminal passageway and is used to receive the guiding portion 120 of the electrical connector 10, and conductive terminal receiving portions 340 which are communicated with the respective counterpart terminal passageways and are used to receive the respective conductive terminals 200 of the electrical connector 10. Based on the specific structure of the electrical connector 10, the counterpart electrical connector 30 may further include a supporting arm receiving portion 350 which is used to receive the supporting arm 117 of the electrical connector 10, a signal terminal group cooperating portion 360 which is used to cooperate with the signal terminal group 220 of the electrical connector 10 to realize mating, and when the electrical connector 10 and the counterpart electrical connector 30 are mated with each other, the signal terminal group cooperating portion 360 is received in the compartment 118 of the electrical connector 10.

In the embodiment as shown in FIGS. 15 and 16, only one supporting arm receiving portion 350 is provided, certainly, corresponding to other different embodiments of the electrical connector 10, the counterpart electrical connector 30 also may be provided with a second supporting arm receiving portion and a third supporting arm receiving portion which are used to respectively receive the second supporting arm 119 and the third supporting arm 113 of the electrical connector 10, but the present disclosure is not limited thereto.

As shown in FIGS. 15 and 16, the guiding portion receiving portion 330, the conductive terminal receiving portions 340 and the supporting arm receiving portion 350 are provided on a mating surface 320 of the counterpart housing 300, and extend from the mating surface 320 toward an interior of the counterpart housing 300. Apparently, the guiding portion receiving portion 330, the conductive terminal receiving portions 340 and the supporting arm receiving portion 350 correspondingly match with the guiding portion 120, the conductive terminals 200 and the supporting arm 117 in shape and size. And the counterpart conductive terminal 400 in each conductive terminal receiving portion 340 also corresponds to the corresponding conductive terminal 200 of the electrical connector 10 in type.

In the case that the electrical connector 10 is provided with the detecting terminal 230, the counterpart electrical connector 30 also is correspondingly provided with a detecting terminal cooperating portion 370, as shown in FIG. 15, the detecting terminal cooperating portion 370 is used to cooperate with the detecting terminal 230 of the electrical connector 10 to realize mating, and when the electrical connector 10 and the counterpart electrical connector 30 are mated with each other, the detecting terminal cooperating portion 370 is received in the compartment 118 of the electrical connector 10.

The electrical connector 10 according to the present disclosure is provided with the guiding portion 120 in a transverse direction of the housing 100, the two side surfaces or one side surface of the guiding portion 120 each are provided with the power terminal 210, so that a guiding post provided on a housing in the prior art may be omitted, a dimension of the electrical connector 10 in the transverse direction is effectively reduced, the creepage distance requirement still may be satisfied at the same time. Moreover, the supporting arm 117, the second supporting arm 119 and the third supporting arm 113 of the electrical connector 10 not only may function as supporting and positioning of the corresponding conductive terminals 200 and assure creepage distance requirement between the adjacent conductive terminals 200, but also may further strengthen the strength of the housing 100.

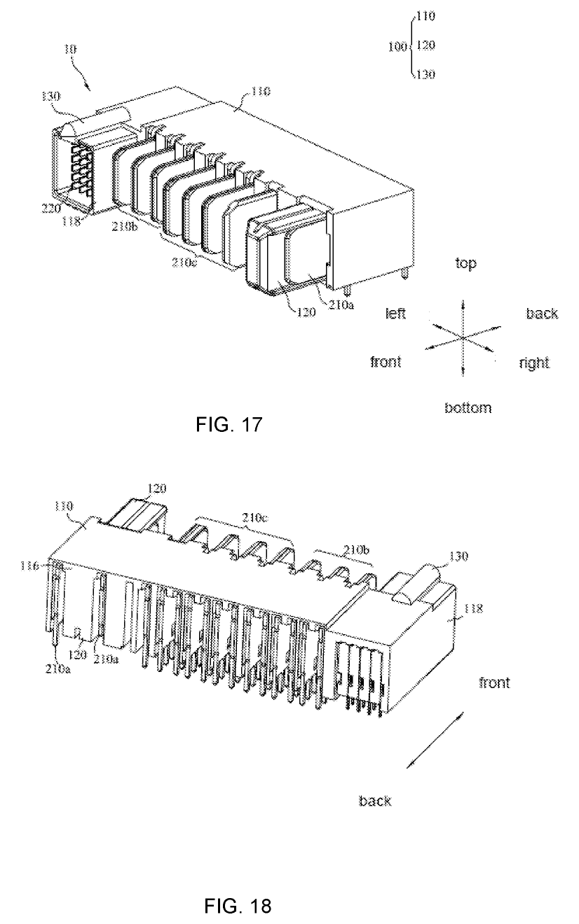

Next referring to FIGS. 17 and 18, a varied embodiment of the electrical connector in plug-type according to the present disclosure is described. Firstly, referring to the schematic view of FIG. 17, FIG. 17 illustrates the electrical connector 10 in plug-type, in the varied embodiment, the signal terminal group 220 is provided at an end of the housing 100 opposite to the guiding portion 120, and a guiding post 130 is provided on a top portion of the compartment 118 which receives the signal terminal group 220 therein. That is to say, according to the varied embodiment as shown in FIG. 17, an extending direction of each terminal is defined as a longitudinal direction of the housing 100 (that is, the front-rear direction as shown in FIG. 17), a direction perpendicular to the longitudinal direction is defined as a transverse direction of the housing 100 (that is, the left-right direction as shown in FIG. 17), one end of the housing 100 along the transverse direction of the housing 100 (for example, a left end in FIG. 17) is provided with the guiding post 130 on the top portion of the compartment 118, the other end of the housing 100 along the transverse direction of the housing 100 (for example, a right end in FIG. 17) is provided with the guiding portion 120, when the electrical connector 10 in plug-type and the counterpart connector are mated with each other, the guiding post 130 and the guiding portion 120 both may function as guiding.

As shown in FIG. 17, the guiding post 130 may be in form of semi-cylinder, and a front end of the guiding post 130 is formed as a semi-cone to facilitate guiding for inserting and mating, at the same time an overall height of the housing 100 is not significantly increased. Certainly, the present disclosure is not limited thereto, the guiding post 130 also may be in form of cylinder, and the front end of the guiding post 130 is formed as a cone. The semi-cone or the cone of the front end of the guiding post 130 may extend forwardly along a top surface of the compartment 118 to be beyond a front surface of the compartment 118, thus may function as guiding when the electrical connector 10 and the counterpart electrical connector begin to be mated with each other.

The top surface of the compartment 118 which is used to receive the signal terminal group 220 is generally lower than a height of the lower-voltage side power terminal 210b and a height of the ground terminal 210c and a height of the base portion 110 of the housing 100 along the up-down direction, that the guiding post 130 is positioned on the top portion of the compartment 118 may better utilize a height difference therebetween, guiding function is realized while an overall dimension of the electrical connector 10 in a height direction is not increased or is not increased too much. Moreover, in comparison with the aforementioned embodiments, because the guiding portion 120 at one side is omitted, so that the dimension of the electrical connector 10 in the transverse direction (that is, a dimension in the left-right direction of FIG. 17) may be further effectively reduced. Certainly, the present disclosure is not limited thereto, it is not necessary for the guiding post 130 to be provided on the top surface of the compartment 118, when the compartment 118 which receives the signal terminal group 220 as shown in FIG. 2 is provided at a middle position, the guiding post 130 also may be directly provided on a top surface of the base portion 110.

Moreover, as shown in FIG. 18, FIG. 18 illustrates the varied embodiment of the electrical connector 10 in plug-type from a rear side of the varied embodiment, in the aforementioned embodiment, as shown in FIGS. 1 and 2, the guiding portion 120 extends forwardly from the front surface 115 of the base portion 110 along the front-rear direction of FIG. 1 to form the cooperating end portion 121 (as shown in FIG. 2), but in the varied embodiment as shown in FIG. 18, the guiding portion 120 may extend forwardly from the rear surface 116 of the base portion 110 of the housing 100 until the guiding portion 120 extends beyond the front surface 115 of the base portion 110, similarly, in comparison with each conductive terminal 200 and the compartment 118, a distance that the guiding portion 120 extends out from the front surface 115 (as shown in FIG. 17) of the base portion 110 is maximum, so that the guiding portion 120 may function as guiding when the electrical connector 10 and the counterpart electrical connector are mated with each other.

Other structures of the guiding portion 120, the housing 100 and each conductive terminal 200 may be the same as those structures of each aforementioned embodiment, and are no longer described repeatedly.

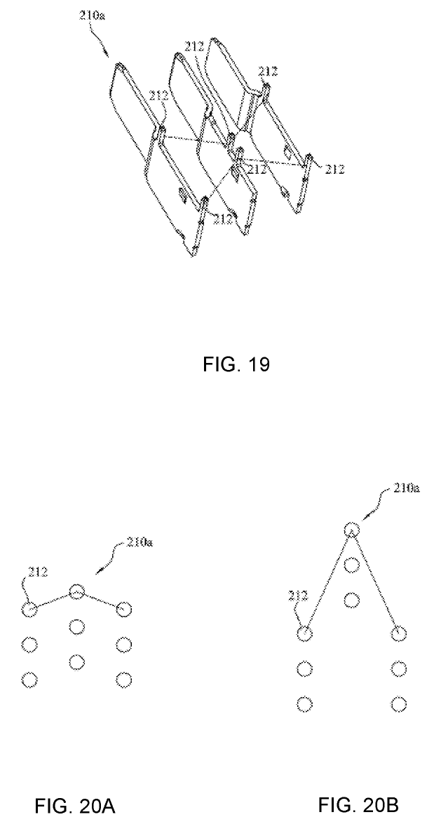

Next referring to FIG. 19, an arrangement structure of soldering legs of the high-voltage side power terminals 210a according to the present disclosure is described, the arrangement structure of the soldering legs of the high-voltage side power terminals 210a described as follows is adapted to the aforementioned embodiments as shown in FIGS. 1-16, and also is adapted to the varied embodiment as shown in FIGS. 17-18.

As shown in FIG. 19, for example, soldering legs 212 of three high-voltage side power terminals 210a are arranged not to be aligned with each other, that is, the soldering legs 212 of the three high-voltage side power terminals 210a are arranged to be staggered with each other, as such, a distance between the soldering legs 212 of the adjacent high-voltage side power terminals 210a is changed to an oblique line (as shown by a dotted line in FIG. 19) from a straight line when the soldering legs 212 of the adjacent high-voltage side power terminals 210a are aligned with each other, so that creepage distance may be increased. Certainly, the arrangement of soldering legs is not limited to that as shown in FIG. 19, as long as creepage distance can be increase, other staggering arrangement also may be feasible, for example, a distance between the soldering legs 212 of the high-voltage side power terminal 210a at each of two sides of the three high-voltage side power terminals 210a is relatively small, a distance between the soldering legs 212 of the high-voltage side power terminal 210a in the middle of the three high-voltage side power terminals 210a is relatively large. Or, as shown in FIGS. 20A and 20B, the soldering legs 212 of different high-voltage side power terminals 210a are arranged to be staggered with each other along longitudinal directions of the different high-voltage side power terminals 210a, for example, the soldering legs 212 of the high-voltage side power terminal 210a in the middle of the three high-voltage side power terminals 210a are closer to a front side (or a rear side) of the housing 100, and the soldering legs 212 of the high-voltage side power terminal 210a at each of two sides of the three high-voltage side power terminals 210a are closer to the rear side (or the front side) of the housing 100, the staggered distance may be increased according to specific requirement, the staggered distance between the soldering legs 212 of the high-voltage side power terminal 210a in the middle of the three high-voltage side power terminals 210a and the soldering legs 212 of the high-voltage side power terminal 210a at each of the two sides of the three high-voltage side power terminals 210a is increased FIG. 20B in comparison with FIG. 20A. FIGS. 20A and 20B illustrate that each high-voltage side power terminal 210a has three soldering legs 212, but the present disclosure is not limited thereto, each high-voltage side power terminal 210a also may be provided with two soldering legs 212.

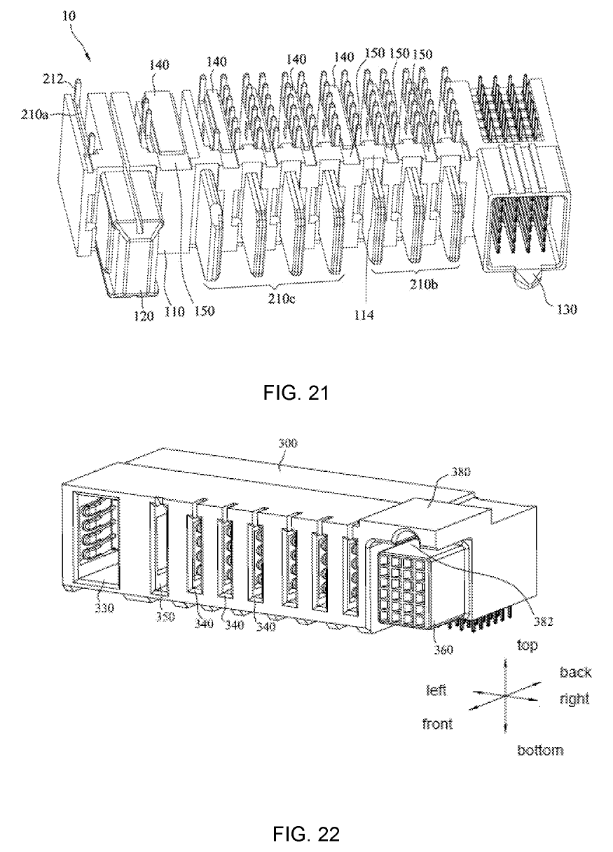

Hereinafter, a bottom structure of the electrical connector 10 in plug-type is described by taking the varied embodiment of the electrical connector as shown in FIG. 17 as example, similarly, the bottom structure described as follows may be adapted to the electrical connector 10 of the aforementioned various embodiments as shown in FIGS. 1-12. As shown in FIG. 21, a bottom surface 114 of the base portion 110 of the electrical connector 10 in plug-type (that is, a surface to be mounted on a PCB) is formed with a plurality of protruding portions 140 and a plurality of recessed portions 150 which are spaced apart from each other, the plurality of recessed portions 150 are lower than the bottom surface 114, that is, the plurality of recessed portions 150 extend from the bottom surface 114 toward the top surface of the base portion 110, and the plurality of protruding portions 140 are respectively formed to/provided to the respective recessed portions 150 in one-by-one correspondence, and may be flush with the bottom surface 114 or may be higher than the bottom surface 114. The plurality of protruding portions 140 and the plurality of recessed portions 150 may be uniformly distributed to the whole bottom surface 114 of the base portion 110, also may be only distributed to a part of the bottom surface 114. The soldering legs of each conductive terminal 200 extends out from between the adjacent protruding portions 140, as such, when the electrical connector 10 is mounted on the PCB, each protruding portion 140 may increase contact area with the PCB, at the same time also may increase strength of the housing 100. Moreover, the plurality of protruding portions 140 and the plurality of recessed portions 150 may further increase creepage distance between the respective conductive terminals 200, and may adjust planeness of the housing 100 in a molding process.

Next referring to FIG. 22, a varied embodiment of a counterpart electrical connector in receptacle-type according to the present disclosure is described. The counterpart electrical connector 30 in receptacle-type is mated with the electrical connector 10 in plug-type as shown in FIG. 17. As shown in FIG. 22, corresponding to the electrical connector 10 in plug-type as shown in FIG. 17, in the counterpart electrical connector 30, the guiding portion receiving portion 330 is formed at one end of the counterpart housing 300 (for example a left end as shown in FIG. 22), the guiding portion receiving portion 330 is communicated with the counterpart terminal passageways and is used to receive the guiding portion 120 of the electrical connector 10; the signal terminal group cooperating portion 360 is formed at the other end (for example a right end as shown in FIG. 22) of the counterpart housing 300, is used to cooperate with the signal terminal group 220 of the electrical connector 10 to realize mating, and when the electrical connector 10 and the counterpart electrical connector 30 are mated with each other, the signal terminal group cooperating portion 360 is received in the compartment 118 of the electrical connector 10. According to the embodiment as shown in FIG. 22, a guiding post receiving portion 380 is provided above the signal terminal group cooperating portion 360, the guiding post receiving portion 380 may be integrally formed with the counterpart housing 300, and the guiding post receiving portion 380 is formed with a groove 382 which is opened toward the signal terminal group cooperating portion 360, when the counterpart connector 30 and the electrical connector 10 are mated with each other, the guiding post 130 of the electrical connector 10 may extend into the groove 382. According to the embodiment as shown in FIG. 22, the groove 382 is in form of semi-circle, certainly, but the present disclosure is not limited thereto, the groove 382 also may be formed as other shape, as long as the groove 382 can engage with the guiding post 130.

Other structures and arrangements of the counterpart electrical connector 30 are the same as those structures and arrangements of the aforementioned counterpart electrical connector 30 as shown in FIGS. 13 and 16, and are no longer described repeatedly.

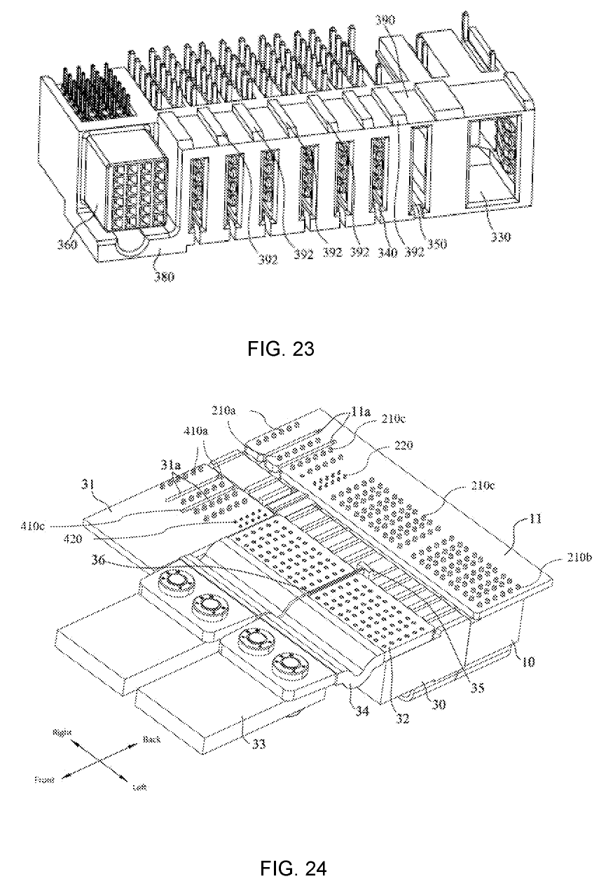

FIG. 23 illustrates a schematic view of a bottom structure of a varied embodiment of the counterpart electrical connector 30 in receptacle-type according to the present disclosure. Similarly, the bottom structure described as follows may be adapted to the counterpart electrical connector 30 according to the aforementioned various embodiments as shown in FIGS. 13-16. As shown in FIG. 23, a plurality of protruding portions 392 which are spaced apart from each other are formed on a bottom surface 390 (that is, a surface to be mounted on a PCB) of the counterpart housing 300 of the counterpart electrical connector 30, that is, the plurality of protruding portions 392 extend out from the bottom surface 390 of the counterpart housing 300. The plurality of the protruding portions 392 may be uniformly distributed on the whole bottom surface 390 of the counterpart housing 300, also may be only distributed on a part of the bottom surface 390, in the embodiment as shown in FIG. 23, the plurality of protruding portions 392 are only distributed on a part of the counterpart housing 300 which is close to a mating end of the counterpart housing 300. Each protruding portion 392 may increase strength of the counterpart housing 300.

Next referring to FIG. 24, a bottom surface after the electrical connector 10 and the counterpart electrical connector 30 according to the present disclosure are mated with each other is described. As shown in FIG. 24, the electrical connector 10 may be electrically connected to a first printed circuit board (PCB) 11, and the first printed circuit board 11 is provided with a first gap 11a, the first gap 11a may be provided at a position of the first printed circuit board 11 corresponding to the high-voltage side power terminal 210a, so as to increase creepage distance. FIG. 24 illustrates the two first gaps 11a, but the present disclosure is not limited thereto, also the first gap 11a may be provided in other number. According to an embodiment not shown, the counterpart electrical connector 30 also may be connected to a second printed circuit board 31, and similarly, a second gap 31a in suitable number also may be provided at a position of the second printed circuit board 31 corresponding to the high-voltage side counterpart power terminal so as to increase creepage distance.

Selectively, as shown in FIG. 24, the high-voltage side counterpart power terminal of the counterpart electrical connector 30 is electrically connected to the second printed circuit board 31, the lower-voltage side counterpart power terminal of the counterpart electrical connector 30 and the counterpart ground terminal at the lower-voltage side of the counterpart electrical connector 30 each are electrically connected to a flexible busbar 32, the flexible busbar 32 is then electrically connected to a rigid busbar 33. In the present embodiment, the lower-voltage side counterpart power terminal is required to carry large current, and the larger the current is, the thicker the printed circuit board which is electrically connected to the lower-voltage side counterpart power terminal is. With the above arrangement, on one hand, it may avoid the lower-voltage side counterpart power terminal being directly connected to the printed circuit board to cause a thickness of the printed circuit board to be increased and result in high cost, on the other hand, by that the lower-voltage side counterpart power terminal of the counterpart electrical connector 30 is connected to the flexible busbar 32, the flexible busbar 32 is then electrically connected to the rigid busbar 33, a problem of assembling tolerance may be further overcome, which facilitates mounting. In the present embodiment, the counterpart ground terminal at the high-voltage side of the counterpart electrical connector 30 and the counterpart signal terminal group of the counterpart electrical connector 30 are both electrically connected to the second printed circuit board 31. However, it should be understood that, in other embodiments, the counterpart grounding terminal and/or the counterpart signal terminal group may, according to actual application requirements, be configured to adopt a connection manner similar to that of the counterpart conductive terminals at the lower-voltage side, for example, by first being electrically connected to a flexible busbar 32 and then electrically connected to a rigid busbar 33.

According to an embodiment not shown, similarly, the high-voltage side power terminal 210a of the electrical connector 10 also may be electrically connected to the first printed circuit board 11, and the lower-voltage side power terminal 210b of the electrical connector 10 and the ground terminal 210c at the lower-voltage side of the electrical connector 10 each may be electrically connected to a flexible busbar, the flexible busbar is then electrically connected to a rigid busbar.

According to further another embodiment not shown, the lower-voltage side counterpart power terminal of the counterpart electrical connector 30 and the counterpart ground terminal at the lower-voltage side of the counterpart electrical connector 30 each are directly electrically connected to a rigid busbar 33, or, each are only electrically connected to a flexible busbar 32. Similarly, the lower-voltage side power terminal 210b of the electrical connector 10 and the ground terminal 210c at the lower-voltage side of the electrical connector 10 each may be directly electrically connected to a rigid busbar, or, each may be only electrically connected to a flexible busbar.

According to yet another embodiment not shown, the high-voltage side counterpart power terminal of the counterpart electrical connector 30 may be directly electrically connected to a rigid busbar 33, or, may be only electrically connected to a flexible busbar 32, or, may be first electrically connected to the flexible busbar 32, the flexible busbar 32 then may be electrically connected to the rigid busbar 33. Similarly, the high-voltage side power terminal 210a of the electrical connector 10 may be directly electrically connected to a rigid busbar, or, may be only electrically connected to a flexible busbar, or, may be first electrically connected to a flexible busbar, the flexible busbar then may be electrically connected to a rigid busbar. Hereinafter, referring to FIG. 24, specific details are described by taking mounting form of the bottom surface of the counterpart electrical connector 30 as example, the details may be similarly adapted to mounting of the bottom surface of the electrical connector 10. The flexible busbars 32 are partitioned by a partitioning wall 36, so that the flexible busbars 32 are partitioned into a part which corresponds to the lower-voltage side counterpart power terminal and a part which corresponds to the counterpart ground terminal at the lower-voltage side, so as to prevent short circuit. Correspondingly, two rigid busbars 33 are respectively electrically connected to the two parts of the flexible busbars 32. Moreover, a partitioning protrude block 35 is further provided to be connected to the partitioning wall 36, so as to promote strength of the partitioning wall 36. A dimension of the partitioning protrude block 35 in a transverse direction (along the left-right direction in FIG. 24) is greater than a dimension of the partitioning protrude block 35 in a longitudinal direction (along the front-rear direction in FIG. 24). The partitioning wall 36 and the partitioning protrude block 35 may be provided on the bottom surface 390 of the counterpart housing 300. Moreover, as shown in FIG. 24, the flexible busbar 32 is further sheathed with a bushing 34 to ensure structure integrity of the flexible busbar 32 and to realize electrical insulation at the same time. The bushing 34 may be a heat-shrinkable bushing, but the present disclosure is not limited thereto. Certainly, it also may employ other manner to prevent the adjacent flexible busbars 32 from being short circuit, so the present disclosure does not make any limitation herein, for example, the adjacent flexible busbars may realize electrical insulation by an insulative partitioning piece.

In practical applications, a connecting manner between each counterpart conductive terminal of the counterpart electrical connector 30 and the exterior and a connecting manner between each conductive terminal of the electrical connector 10 and the exterior may be adjusted according to the application environment requirement. When it is required to prevent the adjacent busbars from being short circuit, it also may select different manners to realize electrical insulation between the adjacent busbars.

Since the features of the present disclosure can be embodied in various forms without departing from the characteristics of the present disclosure, it should be further understood that the above embodiments are not limited to any of the details described above, unless otherwise specified, but should be broadly interpreted as fallen within the scope of the appended claims. Therefore, all modifications and modifications fallen within the scope and boundary of the claims or equivalent solutions of such scope and boundary should be covered by the appended claims.

What is claimed is:

1. An electrical connector, comprising:
a housing; and
conductive terminals,
wherein the housing comprises
a base portion which is provided with a plurality of terminal passageways, the plurality of terminal passageways penetrate from a rear surface of the base portion to a front surface of the base portion, respective ones of the conductive terminals are provided in respective ones of the terminal passageways and are exposed from the front surface of the base portion to form a contacting end portion; and
a guiding portion which extends forwardly from the base portion to form a cooperating end portion, a distance between the cooperating end portion and the front surface of the base portion is greater than a distance between the contacting end portion of the conductive terminal and the front surface of the base portion, a side surface of the guiding portion is provided with a placing groove which allows the corresponding conductive terminal to be inserted therein, the placing groove is communicated with the corresponding terminal passageway so that a part of the corresponding conductive terminal is provided in the corresponding terminal passageway and a part of the corresponding conductive terminal is placed in the placing groove.

2. The electrical connector according to claim 1, wherein the guiding portion is provided at at least one side end portion of two side end portions of the base portion in a transverse direction, and the guiding portion is a partitioning plate which has a thickness.

3. The electrical connector according to claim 1, wherein the guiding portion is provided at at least one side end portion of two side end portions of the base portion in a transverse direction, and the guiding portion is two partitioning plates which are provided to be spaced apart from each other.

4. The electrical connector according to claim 3, wherein the two partitioning plates are filled therebetween with an insulator.

5. The electrical connector according to claim 2, wherein the cooperating end portion of the guiding portion is provided with a guiding oblique surface.

6. The electrical connector according to claim 2, wherein a top portion and/or a bottom portion of the guiding portion is provided with a recessed groove which extends along a front-rear direction.

7. The electrical connector according to claim 6, wherein when the top portion of the guiding portion is provided with the recessed groove which extends along the front-rear direction, the recessed groove extends rearwardly to a top portion of the base portion along the top portion of the guiding portion; and when the bottom portion of the guiding portion is provided with the recessed groove which extends along the front-rear direction, the recessed groove extends rearwardly to a bottom portion of the base portion along the bottom portion of the guiding portion.

8. The electrical connector according to claim 1, wherein the guiding portion comprises a first guiding portion and a second guiding portion, and the first guiding portion and the second guiding portion are respectively provided at two side end portions of the base portion in a transverse direction, and a width of the first guiding portion is greater than a width of the second guiding portion.

9. The electrical connector according to claim 1, wherein the base portion is further provided with a supporting arm, the supporting arm extends forwardly from the front surface of the base portion, and a distance that the supporting arm extends forwardly from the base portion is less than the distance between the cooperating end portion of the guiding portion and the front surface of the base portion; and the conductive terminals comprises at least one ground terminal, the ground terminal is provided at either side of the supporting arm.

10. The electrical connector according to claim 9, wherein either side of the supporting arm is provided with an inserting groove, the ground terminal is partially provided in the corresponding terminal passageway and is partially inserted in the inserting groove.

11. The electrical connector according to claim 9, wherein the ground terminal is divided into a first ground terminal and a second ground terminal which are arranged to be spaced apart from each other.

12. The electrical connector according to claim 1, wherein the base portion is further provided with a second supporting arm, and the second supporting arm is adjacent to one guiding portion and extends forwardly from the front surface of the base portion, and a distance that the second supporting arm extends forwardly from the base portion is less than the distance between the cooperating end portion of the guiding portion and the front surface of the base portion.

13. The electrical connector according to claim 12, wherein the conductive terminal comprises at least one power terminal, a side of the second supporting arm away from the adjacent guiding portion is provided with a second inserting groove, and the corresponding power terminal is partially positioned in the corresponding terminal passageway and is partially inserted into the second inserting groove.

14. The electrical connector according to claim 13, wherein a side surface of the guiding portion adjacent to the second supporting arm away from the second supporting arm is provided with a placing groove, and the corresponding power terminal is partially positioned in the corresponding terminal passageway and is partially positioned in the placing groove.

15. The electrical connector according to claim 1, wherein the conductive terminal comprises a lower-voltage side power terminal, the base portion is further provided with a third supporting arm, the third supporting arm is positioned at a position corresponding to the lower-voltage side power terminal and extends forwardly from the front surface of the base portion, and a distance that the third supporting arm extends forwardly from the base portion is less than the distance between the cooperating end portion of the guiding portion and the front surface of the base portion.

16. The electrical connector according to claim 15, wherein the conductive terminal further comprises a ground terminal, a left side and a right side of the third supporting arm each are provided with a third inserting groove, the lower-voltage side power terminal is partially inserted into the corresponding terminal passageway and is partially inserted into the third inserting groove at one side of the third supporting arm, and the ground terminal is partially inserted into the corresponding terminal passageway and is partially inserted into the third inserting groove at the other side of the third supporting arm.

17. The electrical connector according to claim 1, wherein the base portion is further provided with a compartment, the compartment extends forwardly from the front surface of the base portion, and a distance that the compartment extends forwardly from the base portion is less than the distance between the cooperating end portion of the guiding portion and the front surface of the base portion; and the conductive terminals comprises a signal terminal group constituted by a plurality of signal terminals which are arranged, the signal terminal group is provided in the compartment.

18. The electrical connector according to claim 17, wherein the conductive terminals further comprises power terminals, and the power terminals comprise a lower-voltage side power terminal which is positioned at one side of the signal terminal group and high-voltage side power terminals which are positioned at the other side of the signal terminal group.

19. The electrical connector according to claim 17, wherein the electrical connector is further provided with at least one detecting terminal.

20. The electrical connector according to claim 19, wherein the detecting terminal is also provided in the compartment, and is positioned alongside the plurality of signal terminals, and the detecting terminal and the plurality of signal terminals are provided therebetween with a partitioning wall.

21. The electrical connector according to claim 20, wherein the detecting terminals also are provided therebetween with a partitioning wall.

22. The electrical connector according to claim 19, wherein the conductive terminals further comprises power terminals, and the detecting terminal and the power terminal which has the same electric potential as the detecting terminal are connected as integral by insert molding.

23. The electrical connector according to claim 1, wherein the guiding portion extends forwardly from the front surface of the base portion to form the cooperating end portion, or the guiding portion extends forwardly from the rear surface of the base portion to be beyond the front surface to form the cooperating end portion.

24. The electrical connector according to claim 1, wherein one end of the base portion in a transverse direction is provided with a compartment which is used to receive a signal terminal group, a top portion of the compartment is provided with a guiding post; and the other end of the base portion in the transverse direction is provided with the guiding portion.

25. The electrical connector according to claim 24, wherein the guiding post is in form of semi-cylinder or cylinder, and a front end of the guiding post is formed as a semi-cone or a cone, the semi-cone or the cone of the front end of the guiding post extends forwardly along the top portion of the compartment to be beyond a front surface of the compartment.

26. The electrical connector according to claim 18, wherein soldering legs of the high-voltage side power terminals are arranged to be staggered with each other so that an imaginary line connected between the soldering legs of the adjacent high-voltage side power terminals is an oblique line.

27. The electrical connector according to claim 1, wherein a bottom surface of the base portion is formed thereon with a plurality of protruding portions and a plurality of recessed portions which are spaced apart from each other, and the plurality of recessed portions are lower than the bottom surface, the plurality of protruding portions are flush with the bottom surface or are higher than the bottom surface.

28. An electrical connector assembly, comprising:
the electrical connector of claim 1; and
a counterpart electrical connector which is mated with the electrical connector, the counterpart electrical connector comprising a counterpart housing and counterpart conductive terminals, the counterpart housing being provided with counterpart terminal passageways, the counterpart conductive terminals being provided in the respective counterpart terminal passageways and corresponding to and being mated with the respective conductive terminals of the electrical connector to realize electrical connection,
wherein the counterpart housing comprises:
a guiding portion receiving portion which is communicated with the corresponding counterpart terminal passageway and is used to receive the guiding portion of the electrical connector; and
conductive terminal receiving portions which are communicated with the respective counterpart terminal passageways and are used to receive the respective conductive terminals of the electrical connector, and
wherein the guiding portion receiving portion and the conductive terminal receiving portions are provided on a mating surface of the counterpart housing, and extend from the mating surface toward an interior of the counterpart housing.

29. The electrical connector assembly according to claim 28, wherein
wherein the base portion is provided with a compartment which is used to receive a signal terminal group, and
the counterpart housing of the counterpart electrical connector further comprises:
a supporting arm receiving portion which is used to receive the supporting arm of the electrical connector, the supporting arm receiving portion is provided on the mating surface of the counterpart housing of the counterpart electrical connector and extends from the mating surface toward the interior of the housing; and
a signal terminal group cooperating portion which is used to cooperate with the signal terminal group of the electrical connector to realize mating, and when the electrical connector and the counterpart electrical connector are mated with each other, the signal terminal group cooperating portion is received in the compartment of the electrical connector.

30. The electrical connector assembly according to claim 28,
wherein the base portion is provided with a compartment which is used to receive a signal terminal group, and
wherein the counterpart housing of the counterpart electrical connector further comprises a detecting terminal cooperating portion which is used to cooperate with the detecting terminal of the electrical connector to realize mating, and when the electrical connector and the counterpart electrical connector are mated with each other, the detecting terminal cooperating portion is received in the compartment of the electrical connector.

31. The electrical connector assembly according to claim 28, wherein
the guiding portion receiving portion is formed at one end of the counterpart housing; and
the other end of the counterpart housing is formed with a signal terminal group cooperating portion which cooperates with the signal terminal group of the electrical connector, a guiding post receiving portion is provided above the signal terminal group cooperating portion to receive the guiding post of the electrical connector.

32. The electrical connector assembly according to claim 31, wherein the guiding post receiving portion is formed with a groove which is opened toward the signal terminal group cooperating portion, and when the counterpart electrical connector and the electrical connector are mated with each other, the guiding post extends into the groove.

33. An electrical connector, comprising a housing and conductive terminals, wherein one part of the conductive terminals of the electrical connector is electrically connected to a printed circuit board, and the other part of the conductive terminals of the electrical connector is electrically connected to a busbar.
